(19) United States
(12) Patent Application Publication
(10) Pub. No.: US 2010/0102629 A1
(43) Pub. Date: Apr. 29, 2010

(54) Method for Controlling the Movement of an Adjusting Element in a Motor Vehicle

(75) Inventor: Dejan Djordjevic, Stuttgart (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/561,769

(22) Filed: Sep. 17, 2009

(30) Foreign Application Priority Data
Oct. 24, 2008 (DE) 10 2008 054 248.2

(51) Int. Cl. B60L 1/00

(52) U.S. Cl. 307/10.1

(57) ABSTRACT

A method controls a movement of an adjusting element in a motor vehicle, preferably a window mechanism or a sliding roof. A closing operation is started by a user of the vehicle via a suitable operating unit. The movement of the adjusting element is monitored for resistance and the movement of the adjusting element is stopped upon detection of resistance. After a movement for opening the adjusting element has been stopped the current degree of opening of the adjusting element is determined and compared to a predefinable reference value, the adjusting element moving back automatically to the closed position if the degree of opening is below the predefinable reference value.

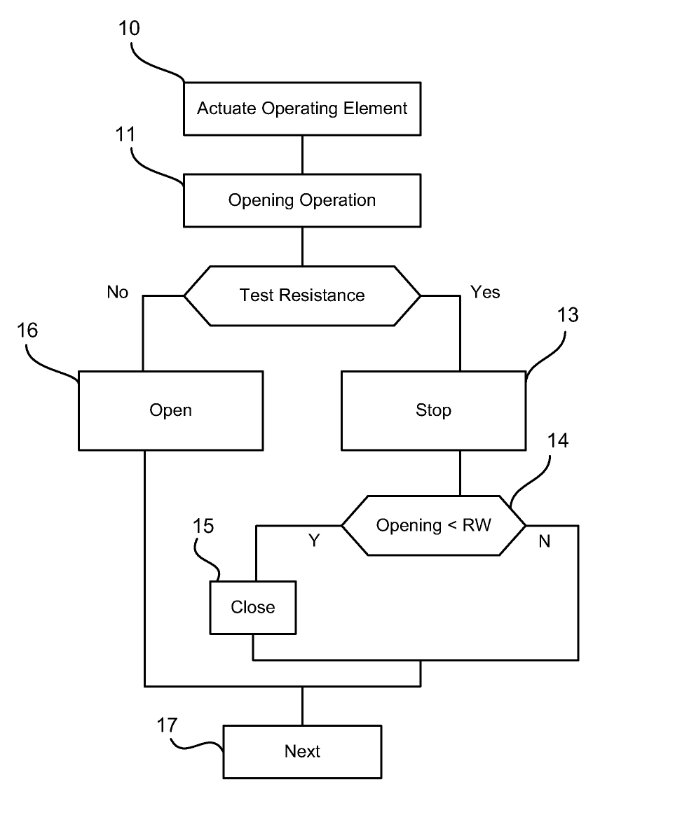

### CROSS-REFERENCE TO RELATED APPLICATION

This application claims the priority, under 35 U.S.C. §119, of German application DE 10 2008 054 248.2, filed Oct. 24, 2008; the prior application is herewith incorporated by reference in its entirety.

### BACKGROUND OF THE INVENTION

### Field of the Invention

The present invention is based on a method for controlling the movement of an adjusting element for opening and/or closing an opening in a motor vehicle.

Methods which take account of various safety requirements when controlling the opening or closing of a movable adjusting element in a motor vehicle, for example a window or a sliding roof, are already known. These safety requirements relate, in particular, to limiting the possible pinching force during the closing movement. For example, a method is known from German patent DE 190 11 982 B4 in which a currently measured value of the motor current is compared to a reference value and a stopping or reversing signal is generated if the reference value is exceeded.

Usually, the limit of the motor torque for the movement is set in such a manner that a danger of pinching is prevented. In this case, a resistance of the adjusting linkage resulting from low temperatures, which may have caused icing of the mechanism, may possibly also be recognized as a resistance and the movement stopped.

### SUMMARY OF THE INVENTION

It is accordingly an object of the invention to provide a method for controlling the movement of an adjusting element in a motor vehicle that overcomes the above-mentioned disadvantages of the prior art methods of this general type, which after resistance has been detected and the movement has been stopped, the sliding roof or window is moved back to a defined position.

With the foregoing and other objects in view there is provided, in accordance with the invention, a method for controlling a movement of an adjusting element in a motor vehicle. The method includes the steps of: starting, via a user, a closing operation of the vehicle by means of a suitable operating unit; monitoring a movement of the adjusting element being monitored for resistance and the movement of the adjusting element being stopped upon detection of the resistance; determining a current degree of opening of the adjusting element after the movement for opening the adjusting element has been stopped; comparing the current degree of opening to a predefinable reference value; and moving the adjusting element back automatically to a closed position if the degree of opening is below the predefinable reference value.

Monitoring of the opening angle after starting of an opening movement and after a stoppage resulting from resistance has the advantage that even a minimal opening which is not perceived by the driver of the vehicle is detected. Unpleasant driving noises caused by an open position are therefore prevented.

In this case it is advantageous, when opening the roof, to determine the resistance and, after a resistance or stiffness has been detected, to determine the instantaneous degree of opening of the adjusting element and then, if the current opening angle is below a defined opening amplitude, to move the adjusting element back to the closed position. It is thereby ensured that an opening gap is avoided which possibly would not be detected by the driver and would remain when the vehicle is parked. If the adjusting element is not completely closed, there is a danger of moisture penetrating the interior of the vehicle.

Other features which are considered as characteristic for the invention are set forth in the appended claims.

Although the invention is illustrated and described herein as embodied in a method for controlling the movement of an adjusting element in a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a program flow chart for carrying out the method according to the invention.

### DETAILED DESCRIPTION OF THE INVENTION

Referring now to the invention in detail and first in particular to the FIGURE of the drawing, there is shown, in a step 10, an operating element for opening an adjusting element being actuated. In the following process step 11 the adjusting element begins to open, the adjusting element begins to move from the closed position in the direction of the open position. In work step 12 the movement is monitored for resistance using known evaluation methods, which are not the subject of the present invention and therefore will not be explained explicitly. If resistance or stiffness is present and the query 12 is answered with “yes”, the movement of the adjusting element stops in step 13.

After the movement of the adjusting element has been stopped, in a query 14 the amplitude of opening of the adjusting element is tested. This is possible in a simple manner since the position of the adjusting element is usually detected by monitoring the motor movement or by a suitable sensor system. This, too, is already sufficiently known in the prior art. If the magnitude of opening is below a predefinable value RW, this query 14 is answered with “yes”. Then, in step 15, the adjusting element is activated to move back in the direction of the “closed position”. The closing movement from the very small opening angle may be performed with an increased closing force so that the closed position is certain to be reached. At the same time the reference value RW for the opening angle is selected so small that, with this small opening gap, an object, or possibly a hand of an occupant of the vehicle, cannot enter the opening of the adjusting element.

If resistance of the movement of the adjusting element has not been detected in query 14, in work step 16 the adjusting element moves to the preselected position of the opening operation, which was triggered in work step 11.

The interrogation of the amplitude of opening in work step 14, and the comparison of the instantaneous degree of opening with a predefinable reference value, is evaluated—if this query is answered in the negative, that is, if the opening is larger than the predefinable reference value—in such a manner that the adjusting element remains in the opened position. The outputs of step 16 and step 15, and the negative output of work step 14, are conducted to a step 17 which ends monitoring of the movement of the adjusting element, with the effect that a defined position has been reached and the defined position will be retained until the adjusting element is next activated.

It is ensured with this method that an adjusting element, such as the sliding roof of a motor vehicle, always remains a defined position visible to the driver after activation of the actuation value for opening the sliding roof, especially at minus temperatures and where there is a danger of icing. For example, if the sliding roof is set in motion and a blockage is detected immediately after the movement has begun, the movement is stopped. In an unfavorable case the adjusting element may have just been opened to a minimal gap, which in turn is not recognized by the driver.

This forced activation for executing a closing operation after a resistance has been detected therefore causes the vehicle and the adjusting element to be in a secured position.

1. A method for controlling a movement of an adjusting element in a motor vehicle, which comprises the steps of:
starting, via a user, a closing operation of the vehicle by means of a suitable operating unit;
monitoring a movement of the adjusting element being monitored for resistance and the movement of the adjusting element being stopped upon detection of the resistance;
determining a current degree of opening of the adjusting element after the movement for opening the adjusting element has been stopped;
comparing the current degree of opening to a predefinable reference value; and
moving the adjusting element back automatically to a closed position if the degree of opening is below the predefinable reference value.

2. The method according to claim 1, wherein the predefinable reference value for the degree of opening corresponds to an amplitude of opening which is not detected optically by the user of the vehicle because of its smallness.

3. The method according to claim 1, wherein the resistance is effected by detection of a motor torque of an adjusting motor and the motor torque is compared to a predefinable reference value.

4. The method according to claim 1, which further comprises selecting the adjusting element from the group consisting of a window mechanism and a sliding roof.
